(19) United States
(12) Patent Application Publication
(10) Pub. No.: US 2004/0133688 A1
(43) Pub. Date: Jul. 8, 2004

(54) Server system using local address

(75) Inventor: Akitake Takamatsu, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/737,806

(22) Filed: Dec. 18, 2003

(30) Foreign Application Priority Data
Dec. 20, 2002 (JP) 2002-370910

(51) Int. Cl. G06F 15/16

(52) U.S. Cl. 709/228

(57) ABSTRACT

The invention provides a server system using a local address, a proxy server, a local server, a server program using the local address and a data communication method using the local address, which enable building-up of a server accessible from the outside even in such a connection environment that only the local address is distributed from a provider. The invention is therefore such that the proxy server receives a request message from a client, judges from a destination address of the request message which local server becomes a destination, has a request message storage unit stored with the request message, with the request message related to the destination local server, receives response information addressed to the client from the local server, and transmits the response information to the client.

### BACKGROUND OF THE INVENTION

The present invention relates to a technology of accessing a home server via a network such as the Internet.

In a case where a user accesses the Internet, it has hitherto been general that a contract with an Internet provider is made, a connection to a server of this Internet provider from a user terminal is established, and there is gained an access to other computer via this server.

The computers connected to the network at this time are respectively assigned IP addresses, and communications are performed based on these IP addresses.

Note that in this IP address, there are a global address unique to throughout the Internet that is allocated by an NIC (Network Information Center), etc. and a private local address (a private IP address) allocated independently by the Internet provider.

The local address may suffice for browsing a Web page, however, the global address was needed for performing, for example, peer-to-peer communications.

Depending on the Internet provider, however, it happened that only the local address was distributed to the terminal of each user.

In this case, there was a problem in which an external computer was unable to access the computer having the local address.

By contrast, in an in-office Intranet, even a server having only the local address can support it by use of a device such as a gateway, etc. for routing in a way that makes a global-to-local address translation (refers to Patent documents 1, 2).

The Internet provider is, however, hard to perform a gateway/routing service suited to a circumstance for every user.

An expanding tendency of a home server market is now predicted, there will increase demands for accessing in-home servers from the outside such as building up Web servers on an individual basis, home automation services by which information-oriented homes are accompanied, and so forth.

It seems, however, difficult in terms of a deficiency problem of global addresses to distribute the global addresses for all the connections.

[Patent Document 1]

Japanese Patent Application Laid-Open Publication No. 10-32610 (paragraphs 62-74, FIG. 3, FIG. 5)

[Patent document 2]

Japanese Patent Application Laid-Open Publication No. 2002-9846 (paragraphs 23-40, FIG. 1)

### SUMMARY OF THE INVENTION

The invention is devised in view of such problems to the prior arts. Namely, an object of the invention lies in providing a technology that enables building-up of a server accessible from the outside even in such a connection environment that only a local address is distributed from a provider.

The invention adopts the following means in order to solve the problems given above.

In a server system using a local address, a proxy server, a local server, a server program and a data communication method according to the invention, the proxy server receives a request message from a client, judges from a destination address of the request message which local server becomes a destination, has a request message storage unit stored with the request message, with the request message related to the destination local server, receives response information addressed to the client from the local server, and transmits the response information to the client.

Thus, the proxy server receives the request message from the client, and confirms the request message from the client by a polling operation from the local server, thereby avoiding a problem that a message from a sender side can not be received because of having no local address of the home server.

<Readable-by-Computer Recording Medium>

The invention may be a recording medium that is recorded with the program readably by the computer.

Then, the computer is made to read and execute the program on this recording medium, whereby the functions thereof can be provided.

Herein, the readable-by-computer recording medium connotes recording mediums capable of storing information such as data, programs, etc.

electrically, magnetically, optically and mechanically or by chemical action, which can be read from the computer.

What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory. and so on are recording mediums fixed to the computer.

In the invention, the components described above can be combined to the greatest possible degree.

### DESCRIPTION OF THE DRAWINGS

FIG. 1 is a view showing an example of an architecture of a server system according to the invention;

FIG. 2 is a diagram of an outline of an architecture of a proxy server;

FIG. 3 is a diagram of an outline of an architecture of a home server;

FIG. 4 is an explanatory diagram of a URL table;

FIG. 5 is a diagram showing an operation sequence of the server system according to the invention;

FIGS. 6A-C are diagrams showing formats of respective messages; and

FIG. 7 is a diagram showing an operation sequence in a modified example.

### DETAILED DESCRIPTION OF THE INVENTION

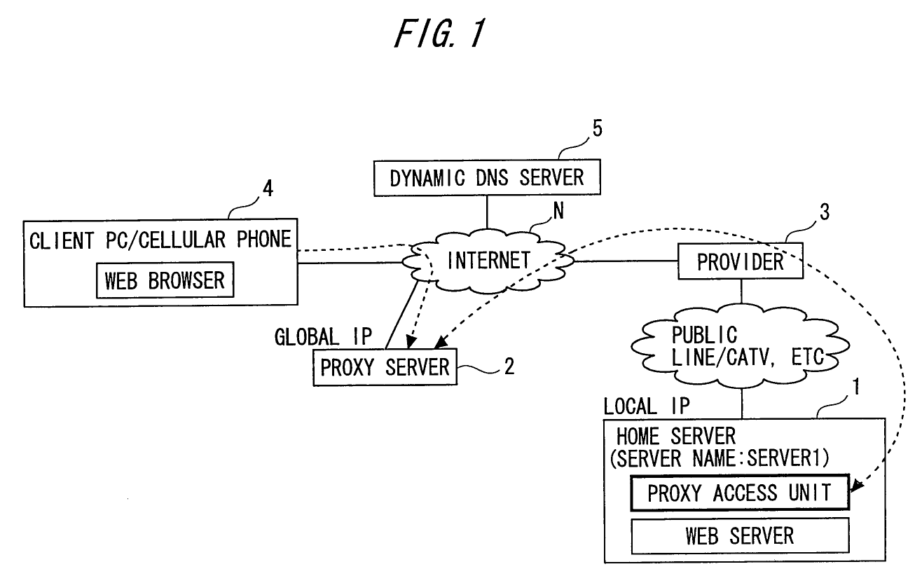

A server system using a local address according to the invention will hereinafter be explained based on the drawings in FIGS. 1 through 6.

<System Architecture>

FIG. 1 is a view showing an example of an architecture of the server system in the embodiment.

As shown in the same Figure, in the embodiment, a home server (corresponding to a local server) 1 is connected to a proxy server 2 via a network N such as the Internet, etc.

Herein the home server 1 is connected via a provider 3 to the Internet N and is assigned a local address from a provider 3.

On the other hand, the proxy server 2 is assigned a global address and relays an access to the home server 1 from a client 4 such as a cellular phone, a personal computer, etc.

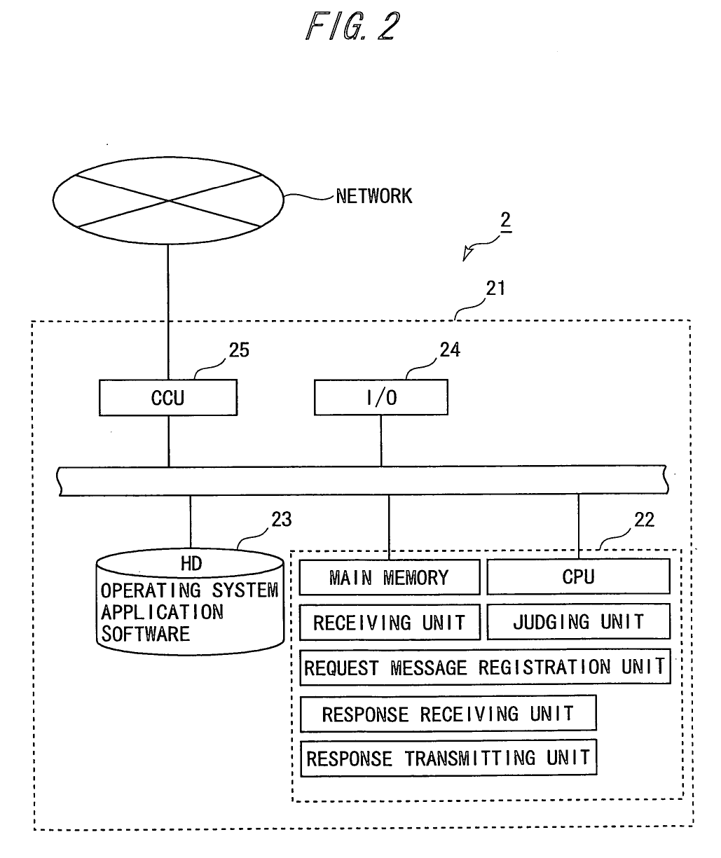

FIG. 2 is a diagram of an outline of an architecture of the proxy server 2. As shown in the same Figure, the proxy server 2 has, within its main body 21, an arithmetic processing unit 22 including a CPU (central processing unit) and a main memory, a storage device (a hard disk) 23 stored with data for the arithmetic process and software, an input/output unit 24, and a communication control device (CCU: Communication control Unit) 25 and so on.

An input device such as a keyboard, a mouse, etc. and an output device such as a display device, a printer, etc. are accordingly connected to the input/output unit 24.

The CCU 25 performs communications with other computers via the network.

An operating system (OS) and application software (which is a server program using the local address) are preinstalled into the storage device 23. The storage device 23 functions also as a request message storage unit for storing a request message. Further, the storage device 23 is stored with a URL table in which the home server 1 is set mapping to a URL (Uniform Resource Locator).

The arithmetic processing unit 22 actualizes, through an arithmetic process according to the server program, functions of a receiving unit, a judging unit, a request message registration unit, a response receiving unit, a response transmitting unit, and so forth.

The arithmetic processing unit 22 receives, as the function of the receiving unit, a request message from the client 4.

Further, the arithmetic processing unit 22 refers to the URL table and judges from a destination address (URL) of the request message, as the function of the judging unit, which home server 1 becomes a destination.

The arithmetic processing unit 22, as the function of the request message registration unit, has the received request message stored in the request message storage unit in a way that sets it mapping to the destination home server 1.

The arithmetic processing unit 22, as the function of the response receiving unit, receives response information addressed to the client from the home server 1.

Then, the arithmetic processing unit 22, as the function of the response transmitting unit, transmits the response information to the client.

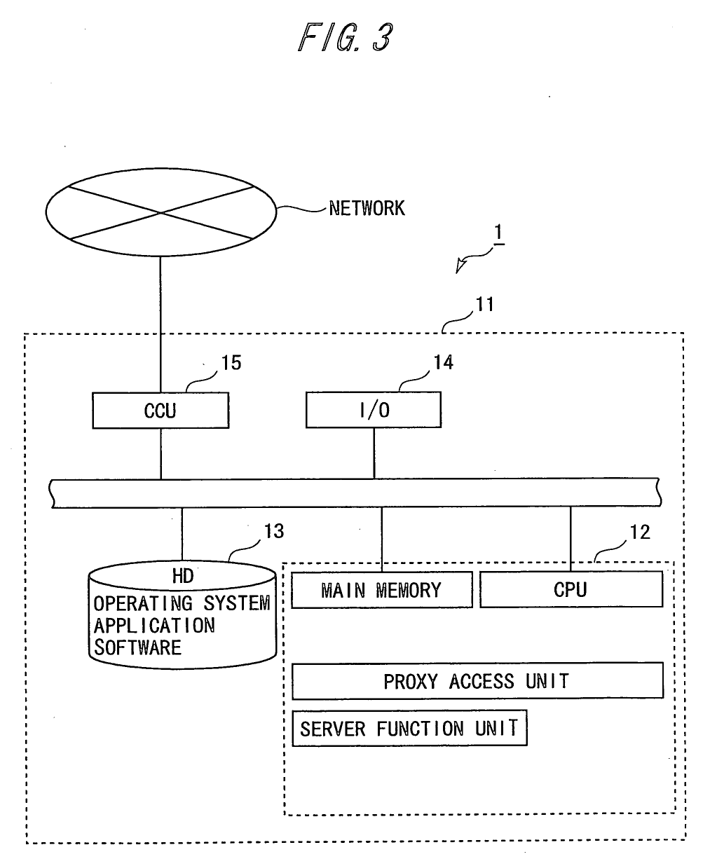

FIG. 3 is a diagram of an outline of the home server 1. As shown in the same Figure, the home server 1 has, within its main body 11, an arithmetic processing unit 12 constructed of a CPU (central processing unit), a main memory, etc., a storage device (a hard disk) 13 stored with data for the arithmetic process and software, an input/output unit 14, a communication control device (CCU: Communication control Unit) 15 and so on.

The input device such as the keyboard, the mouse, etc. and the output device such as the display device, the printer, etc. are accordingly connected to the input/output unit 14.

The CCU 15 performs communications with other computers via the network.

The operating system (OS) and the application software (which is the server program using the local address) are preinstalled into the storage device 13. The storage device 13 functions also as a request message storage unit for storing a request message. Further, the storage device 13 is stored with a URL table in which the home server 1 is set mapping to a URL (Uniform Resource Locator).

The arithmetic processing unit 12 actualizes, through an arithmetic process according to the server program, functions of a proxy access unit, a server function unit, and so forth.

The arithmetic processing unit 12, as the function of the proxy access unit, accesses the request message storage unit of the proxy server 2 and acquires a request message (which corresponds to a request message acquisition unit). Further, the arithmetic processing unit 12, as the function of the proxy access unit, transmits the response information to the proxy server (which corresponds to a response transmitting unit).

Moreover, the arithmetic processing unit 12, as the function of the server function unit, provides the response information based on the acquired request message.

<Data Communication Method Using Local Address>

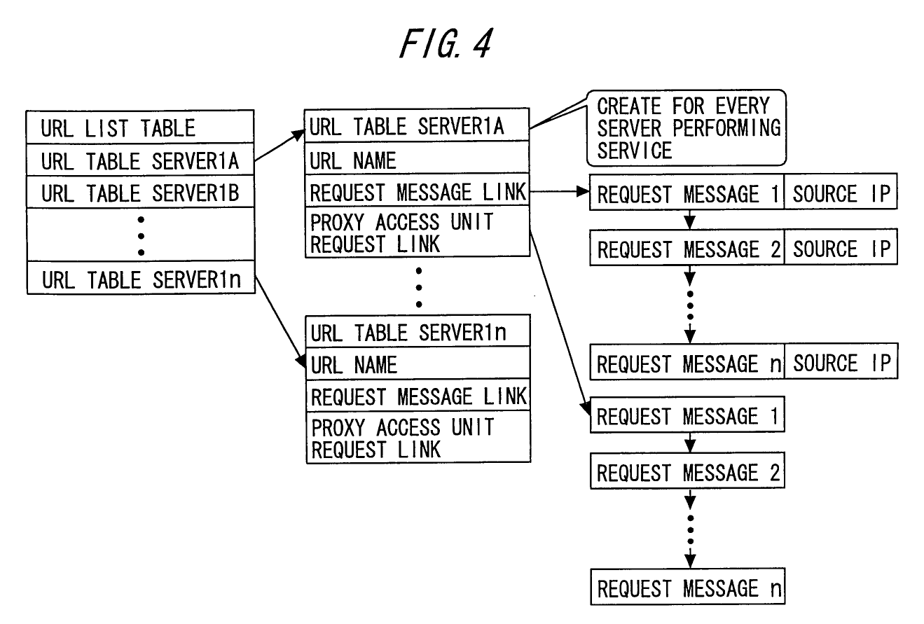

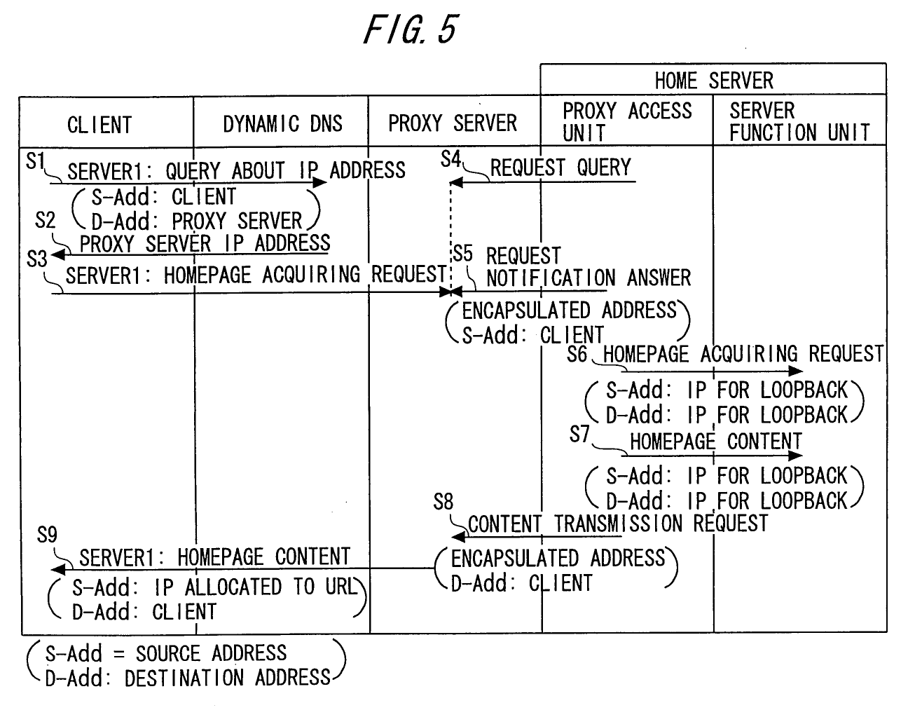

Next, a data communication method in the server system in the embodiment will be described by use of FIGS. 4, 5.

To begin with, the user, who installs the home server 1, acquires a domain name of the home server 1, and registers a URL of this home server and an IP address (a global address) of the Proxy server in a dynamic DNS server 5.

Further, the user registers the URL of the home server in the proxy server 2. The proxy server 2 has the URL table stored with this home server and the URL that are set mapping to each other. All pieces of URLs may be stored in one table, however, the URL table is, as in FIG. 4, created for every server that provides the service in the example.

Moreover, in the embodiment, this URL table also serves as a request message storage unit, and is stored with a request message link in which the request message is set mapping to a source IP address (a sender side IP address) and with a request message (a home server-addressed request link) to be sent to the home server.

FIG. 5 shows an operation sequence in a case where the client 4 browses a homepage of the home server 1.

To start with, the user designates the URL of the home server (Server1A in the example) through the Web Browser on the client (PC/cellular phone) 4. With this, the client 4 queries the dynamic DNS 5 about an IP address (step 1 which will hereinafter be abbreviated such as S1).

The dynamic DNS 5 resolves the URL of this server name: Server1, and sends the IP address (the global address) of the registered proxy server 2 to the client 4 (S2).

The client 4 sends the request message making a request for the homepage of the Server1 to the IP address acquired in step 2, i.e., to the proxy server 2 (S3).

The proxy server 2, as the function of the receiving unit, receives this request message, sets the IP address of the client 4 thereof ad the request message as a request message link, and has the URL table stored with it. Note that the proxy server 2, when establishing this connection, acquires the URL serving as a destination of the request message from the client 4 and, as the function of the judging unit, judges by referring to the URL table which home server becomes the destination of the request message. Then, the proxy server 2 has the request message stored in the URL table of the judged home server.

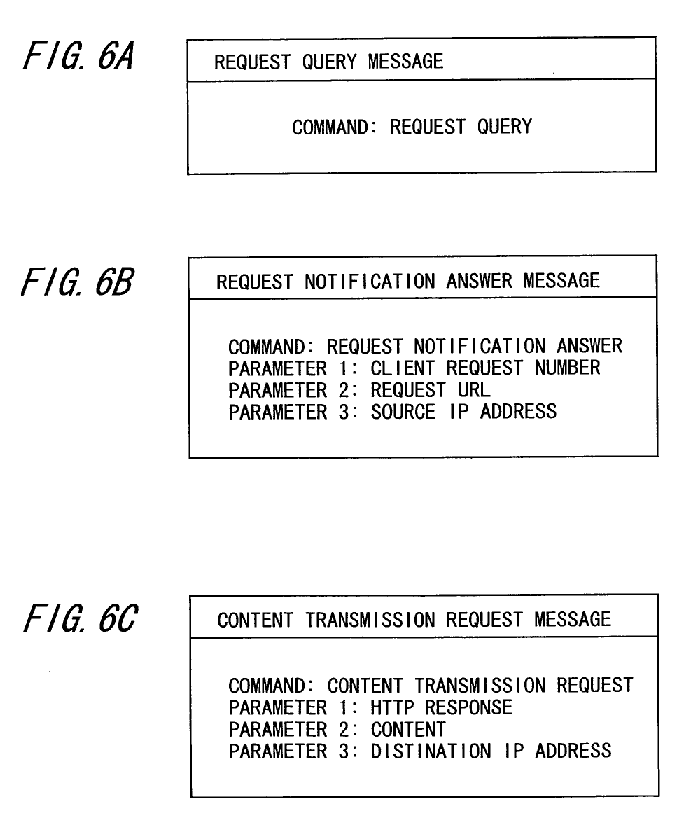

On the other hand, the home server 1, when started up, as the function of the proxy access unit, queries about whether or not the request message is stored in the URL table (the request message storage unit), i.e., sends a request query message (FIG. 6A) at an interval of a predetermined time (S4).

The proxy server 2, upon the request query from the home server 1, refers to the URL table and, in case the request message to the home server 1 is stored, notifies of this request message, i.e., sends a request notification answer message (FIG. 6C) (S5).

The home server 1 notifies the server function unit of this request message (which is a homepage acquisition request in the example) from the proxy access unit (S6). The home server 1 transfers, based on this homepage acquisition request, a homepage content to the proxy access unit (S7).

The proxy access unit of the home server 1 sends to the proxy server 2 a content transmission request message (response information: FIG. 6C) containing the homepage content (S8).

The proxy server 2 receives, as the function of the response receiving unit, this content transmission request message and sends, as the function of the response transmitting unit, the homepage content to the client 4 on the basis of an IP address of the client 4, which has been encapsulated in the content transmission request message (S9).

As the above, according to the embodiment, it is possible to access the home server assigned the local address, and even in the connection environment where only the local address is distributed from the provider, the server accessible from the outside can be built up.

### MODIFIED EXAMPLES

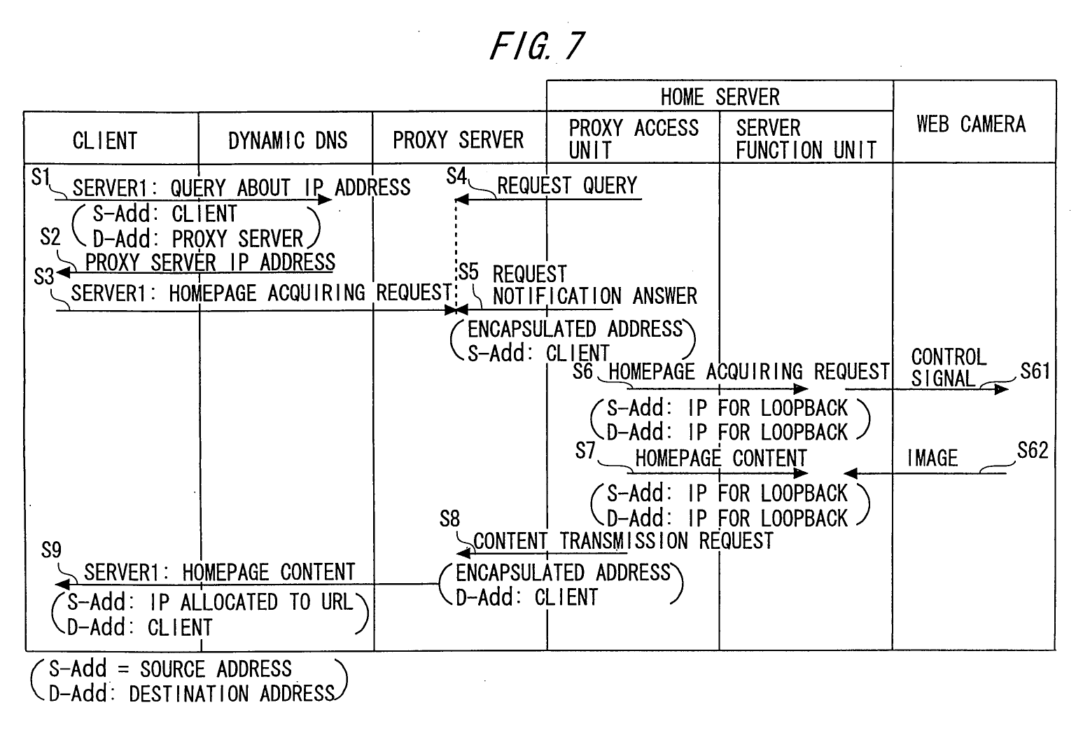

FIG. 7 is a diagram showing an operation sequence in a modified example of the embodiment. In the modified example, the home server 1 includes a Web camera (unillustrated) as input means and controls the Web camera in accordance with a request message given from an external computer.

When the user designates a URL of a Web page on which an image of the in-home Web camera is displayed from on the cellular phone (client) 4, in the same way as in the embodiment, the request message with a purport of making a request for the page is sent to the home server 1 via the proxy server 2 (S1˜S6).

In response to this, the server function unit of the home server 1 switches ON a power source of the Web camera and controls the Web camera to perform photographing (S61).

The Web camera performs the photographing under this control and inputs image information to the server function unit of the home server (S62).

The home server 1 transmits the Web page displaying this image to the client 4 in the same way as the above-mentioned (S7˜S9).

Thus, according to the example, it is feasible to check how the inside of the home is by accessing the home server from where the user goes out.

Note that the appliance controlled by the home server may be a TV, a video, an air-conditioner, etc. without being limited to the Web camera.

<<Other Embodiments>>

The invention is not limited to only the illustrated examples and can have, as a matter of course, additions of a variety of changes within the range that does not deviate from the gist of the invention.

What is claimed is:

1. A server system using a local address, characterized in that a local server assigned a local address is connected via a network to a proxy server assigned a global address,
the proxy server including:
a request message receiving unit receiving a request message from a client;
a request message storage unit storing the request message;
a judging unit judging from a destination address of the request message which local server becomes a destination;
a request message registration unit having the request message storage unit stored with the request message, with the request message related to the destination local server;
a response receiving unit receiving response information addressed to the client from the local server; and
a response transmitting unit transmitting the response information to the client,
the local server including:
a request message acquisition unit acquiring a request message from the request message storage unit of the proxy server;
a server function unit providing the response information based on the request message acquired; and
a response transmitting unit transmitting the response information to the proxy server.

2. A server system using a local address according to Note 1, further including a URL table in which the local server is set mapping to an URL,
wherein the judging unit, in the case of receiving the request message, acquires the URL as a destination address of the request message and judges which local server becomes a destination by referring to the URL table.

3. A proxy server including:
a request message receiving unit receiving a request message from a client;
a request message storage unit storing the request message;
a judging unit judging from a destination address of the request message which local server becomes a destination;
a request message registration unit having the request message storage unit stored with the request message, with the request message related to the destination local server;
a response receiving unit receiving response information addressed to the client from the local server; and
a response transmitting unit transmitting the response information to the client.

4. A proxy server according to Note 3, further including a URL table in which the local server is set mapping to an URL,
wherein the judging unit, in the case of receiving the request message, acquires the URL as a destination address of the request message and judges which local server becomes a destination by referring to the URL table.

5. A proxy server assigned a global address, including:
a request message receiving unit receiving a request message from a client;
a request message storage unit storing the request message;
a judging unit judging from a destination address of the request message which local server becomes a destination;
a request message registration unit having the request message storage unit stored with the request message, with the request message related to the destination local server;
a response receiving unit receiving response information addressed to the client from the local server; and
a response transmitting unit transmitting the response information to the client, and
a local server assigned a local address, including:
a request message acquisition unit acquiring a request message from the request message storage unit of the proxy server;
a server function unit providing the response information based on the request message acquired; and
a response transmitting unit transmitting the response information to the proxy server.

6. A recording medium recorded with a server program for making a computer execute step of:
receiving a request message from a client;
judging from a destination address of the request message which local server assigned a local address becomes a destination;
having a request message storage unit stored with the request message, with the request message related to the destination local server;
receiving response information addressed to the client from the local server; and
transmitting the response information to the client.

7. A recording medium recorded with a server program according to Note 6, wherein the computer further comprises a URL table in which the local server is set mapping to an URL, and
the judging unit, in the case of receiving the request message, acquires the URL as a destination address of the request message and judges which local server becomes a destination by referring to the URL table.

8. A recording medium recorded with a server program for making a proxy server assigned a global IP execute step of:
receiving a request message from a client;
judging from a destination address of the request message which local server assigned a local address becomes a destination;
having a request message storage unit stored with the request message, with the request message related to the destination local server;
receiving response information addressed to the client from the local server; and
transmitting the response information to the client, and for making a local server assigned a local address, execute step of:
acquiring a request message from the request message storage unit of the proxy server;
providing the response information based on the request message acquired; and
transmitting the response information to the proxy server.

9. A data communication method using a local address, for making a computer execute step of:
receiving a request message from a client;
judging from a destination address of the request message which local server assigned a local address becomes a destination;
having a request message storage unit stored with the request message, with the request message related to the destination local server;
receiving response information addressed to the client from the local server; and
transmitting the response information to the client.

10. A data communication method using a local address according to Note 8, wherein the computer further comprises a URL table in which the local server is set mapping to an URL,
wherein the judging unit, in the case of receiving the request message, acquires the URL as a destination address of the request message and judges which local server becomes a destination by referring to the URL table.

11. A data communication method using a local address, for making a proxy server assigned a global IP execute step of:
receiving a request message from a client;
judging from a destination address of the request message which local server assigned a local address becomes a destination;
having a request message storage unit stored with the request message, with the request message related to the destination local server;
receiving response information addressed to the client from the local server; and
transmitting the response information to the client, and for making a local server assigned a local address, execute step of:
acquiring a request message from the request message storage unit of the proxy server;
providing the response information based on the request message acquired; and
transmitting the response information to the proxy server.

12. A server program for making a computer execute step of:
receiving a request message from a client;
judging from a destination address of the request message which local server assigned a local address becomes a destination;
having a request message storage unit stored with the request message, with the request message related to the destination local server;
receiving response information addressed to the client from the local server; and
transmitting the response information to the client.

13. A server program for making a proxy server assigned a global IP execute step of:
receiving a request message from a client;
judging from a destination address of the request message which local server assigned a local address becomes a destination;
having a request message storage unit stored with the request message, with the request message related to the destination local server;
receiving response information addressed to the client from the local server; and
transmitting the response information to the client, and for making a local server assigned a local address, execute step of:
acquiring a request message from the request message storage unit of the proxy server;
providing the response information based on the request message acquired; and
transmitting the response information to the proxy server.
